(19) United States
(12) Patent Application Publication
(10) Pub. No.: US 2018/0184464 A1
(43) Pub. Date: Jun. 28, 2018

(54) SYSTEM AND METHOD FOR PAIRING DEVICES TO CLOUD-BASED APPLICATIONS

(71) Applicant: SafeNet International, LLC, Arlington Heights, IL (US)

(72) Inventor: Joseph Y. Fang, South Barrington, IL (US)

(21) Appl. No.: 15/455,769

(22) Filed: Mar. 10, 2017

Related U.S. Application Data
(60) Provisional application No. 62/439,540, filed on Dec. 28, 2016.

(51) Int. Cl. H04W 76/02; H04L 12/66; H04L 29/12; H04L 29/06; H04L 29/08

(52) U.S. Cl. CPC H04W 76/023; H04L 12/66; H04L 67/10; H04L 65/4076; H04L 61/6022; H04L 61/2007

(57) ABSTRACT

A system and method for automatically pairing local electronic devices with a gateway after registration of such electronic devices by a manufacturer. A lookup table is generated from the registration information and stored on an information platform connected to the gateway. A unique identification code, such as a 2D barcode, is assigned to each registered device. A scan of the barcode by the gateway retrieves information about the device which is then compared to the information on the lookup table of the information platform. If a match exists, pairing information is sent to the gateway and the device is automatically paired with the gateway at power up. Traditional pairing between the electronic device and the gateway can be accomplished when no match is found using a cellular phone.

### RELATED APPLICATION

This application claims the filing priority of Provisional Application Ser. No. 62/439,540, titled “Method of Pairing Bluetooth/Zig-bee Devices to a Home Gateway without Using an Intermediary Hub and Output Common Data Format APIs to Cloud based Applications,” filed on Dec. 28, 2016. The '540 application is hereby incorporated by reference.

### TECHNICAL FIELD OF THE INVENTION

The present invention relates to systems and method used to pair electronic devices to cloud-based applications. Specifically, the invention relates to systems and methods which are capable of automatically pairing devices to cloud-based applications without user knowledge or input.

### BACKGROUND OF INVENTION

For any application provider, automatically connecting and controlling various “Internet of Things” (IoT) devices at runtime is mission critical. Once one is able to control different manufacturer IoT device interfaces, home automation (e.g., obtaining numerous IoT devices' data and controlling them) becomes easy.

The heart of any home automation system is the gateway. It is capable of connecting different IoT devices, such as home appliances, healthcare monitors, thermostat, smoke detector, motion, contact sensors, for home information collection (input and output), integration, and remote monitoring for proper actions. The gateway uses WiFi to transmit information through a home router to the Internet so that it can be connected to a Cloud-based application and be accessed remotely by any Internet device, such as a cellular phone or a computer. However, there is not a common interface applied to home automation to unify various IoT devices' interfaces, nor is there a gateway that is able to interpolate different command structures or data formats.

The reason for the lack of uniformity is obvious. Every home appliance or control device can be made by many different manufacturers and each manufacturer uses different data structures and interfaces for its devices. One solution suggests having a standard uniform format for interfaces. However, this would require all manufacturers to agree on a single format and adopt it in its devices. This is an unlikely scenario, though some giant information companies such as Google, Intel, and Microsoft may team up one day to work on such a uniform protocol.

Another possible solution suggests translating different IoT device interfaces in the gateway. China Unicom and Huawei use either embedding a SDK (software development kit) provided by a manufacturer in the gateway or offering a USB port on the gateway to allow a manufacture to provide executables in a USB card to conduct runtime translations. It effectively helps a manufacturer device connected at runtime. However, this approach lacks expansion, such as the ability to handle many different manufacturer devices at one home, which is all too common.

There are basically three options for connecting IoT devices to the Cloud. First, an IoT device can directly connect to the Cloud through the Internet using wired or wireless data transmission. For example, the IoT device may be a cellular phone, a home/business computer, or a communication system carried by a vehicle. In each case, the device directly connects to the Cloud using wired and/or wireless data transmissions. Second, an IoT device may use BLUETOOTH™ technology or ZigBee™ protocol to transmit to a gateway, which connects to a router using WiFi before the transmission reaches the Cloud through the Internet. This type of IoT device can be equipped with a WiFi transmitter that connects it to a router, then to the Cloud directly. For example, the IoT devices may be a group of gas meters or electric meters connected to apartment units and located in a central room in an apartment building. It can save significant costs to have Bluetooth™ or ZigBee™ transmit data through a gateway to the Cloud rather than paying roaming costs to connect to the Cloud separately.

A third option for connecting to the Cloud involves the use of sensors, such as those produced by a manufacturer for a solution provider. These sensors might be based on motion, contact, video, sound, or the type of sensor used in home appliances for home automation. These sensors use either Bluetooth™ or ZigBee™ to transmit data to a gateway. The gateway uses WiFi or a wired connection to a router which connect to the Cloud via the Internet. These devices are required to meet a standard defined by the gateway in order for the gateway to pair with the device (initialization) and transmit data to the Cloud. Alternatively, these IoT devices can pair with a cell phone (via an APP) as a gateway by Bluetooth™ to transmit to the Cloud separately (integrated in the Cloud level).

The Bluetooth Special Interest Group (SIG) recently announced the release of Bluetooth 4.2, an update that makes it easier for various simple devices to talk directly to one another without using a hub like a cellular phone or computer as an intermediary. Such an improvement is limited due to the concern for privacy. That is, a Bluetooth device cannot simply connect to and track to an IoT device in or near a person's home unless permission is given by way of authorization to pair.

For solution providers, the difficulty is, as noted above, integrating various home IoT devices from different manufacturers and interfacing the devices without requiring any of the manufacturers to modify their devices. For IoT device manufacturers, easier pairing to a Bluetooth device with a gateway (including a Cellular phone APP) and improving the usability experience are equally important for market breakthrough, especially to those who were left behind the wave of new Internet and Information technology.

The disclosed system creates a way to allow different home automation devices to automatically connect to a gateway. It can be accomplished by combining a home gateway with cloud-based software applications which assists the gateway to scan and connect to nearby IoT devices. It is capable of converting different data structures and instruction formats to XML/Jason format (a data-interexchange format) which is easy for a Cloud application to parse.

The present system is capable of pairing Bluetooth IoT devices to a home gateway without using a hub like a cellular phone or a computer as an intermediary. The system also provides a common API for the Cloud application to facilitate obtaining data and controlling IoT devices without knowing the manufacturer or data format of the device. The disclosed system will benefit those who lack the knowledge of how to pair a device to a smart phone, and it will simplify the operation to connect Bluetooth devices in a house, specifically those devices which are disconnected by being powered off or switched off by others. The system will also prevent situations where multiple devices require many cellular phone Apps to pair. It is important to solution providers to not worry about interfaces between IoT devices and Cloud applications. Use of a common API makes it unnecessary for manufacturers to modify the interface in order to integrate with a specific Cloud application, and the reverse is also true with respect to Cloud applications not modifying the interface to suit specific devices.

The disclosed system offers a gateway which makes it easy for nearby IoT devices to connect without the traditional pairing process and it provides Jason format common interfaces to the Cloud so that manufacturers do not need to modify original device interfaces (data and structural format) for a specific gateway and a Cloud-based application.

Until the invention of the present application, these and other problems in the prior art went either unnoticed or unsolved by those skilled in the art. The present invention provides both a system and method for automatically and effectively pairing IoT devices to Cloud-based applications without sacrificing privacy.

### SUMMARY OF THE INVENTION

There is disclosed herein an improved system which avoids the disadvantages of prior devices while affording additional benefits and operating advantages.

This invention address a method makes a gateway able to automatically connect various IoT devices with local network protocol such as Bluetooth and Zig-bee at runtime without use of traditional efforts in so-called pairing the device.

Generally speaking, the disclosed system for automatically pairing an electronic device to a gateway to allow control and operation of the device through a cloud-based application, comprises any number of electronic devices, each having an associated unique identification code, a cloud-based information platform having an IP address, and a gateway.

In specific embodiments of the system, the information platform generates and updates a first device table listing unique identification codes for registered electronic devices, and the gateway comprises a sensor for detecting a broadcast from the electronic device, a code scanner for reading unique identification codes, memory having a second device table of registered electronic devices and the IP address of the information platform, and software for operating the sensor and scanner, wherein the gateway electronically connects to the cloud-based information platform using the stored IP address of the information platform.

In other specific embodiments, the gateway scans the unique identification code associated with the electronic device it sends the unique identification code to the information platform which compares the unique identification code associated with the electronic device against unique identification codes listed on the first device table and, if a match is found, returns additional information on the electronic device to the gateway which automatically pairs to the electronic device when it is powered on.

Another feature of the system may include a router, wherein the gateway connects to the router using WiFi and the router connects to the information platform via the Internet.

Preferably, the electronic devices can be controlled from cloud-based applications when paired with the gateway.

The disclosed method for automatically pairing electronic devices to cloud-based applications, comprises the steps of registering a plurality of electronic devices to a cloud-based information platform, assigning each registered electronic device a unique identification, creating a first device table on the information platform listing the unique identification of each of the plurality of registered electronic devices, scanning from the gateway to detect a signal broadcast from a local electronic device capable of pairing with the gateway, wherein the signal broadcast comprises a first unique identification, sending the first unique identification from the gateway to the information platform, comparing the first unique identification against unique identifications of registered electronic devices listed on the device table stored on the information platform, sending information about pairing with the local electronic device only if the first unique identification matches a unique identification of a registered electronic device, and automatically pairing the gateway with the local electronic device having a first unique identification which matches a unique identification listed on the stored device table when the electronic device is powered on.

In specific embodiments, the method further comprises the steps of periodically updating the device table at the information platform with additional registered devices and creating a second device table on the gateway comprising information about local electronic devices which match registered electronic devices on the information platform.

Additionally, the method may comprise the step of translating information from the electronic device to create a common API as well as the step of transmitting the common API to cloud-based applications. Preferably, a common API is created for each registered device and stored at the information platform.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a flow diagram illustrating the position of a gateway in a smart home system;

FIG. 2 is a flow diagram similar to FIG. 1 with an added Cloud-based Information Platform to connect the gateway to a Cloud based application;

FIG. 3 is a diagram illustrating an embodiment of the disclosed system with automatic connection to IoT devices and a common API for Cloud applications;

FIG. 4 illustrates an embodiment of a device lookup table in which a IoT device name, MAC address and UID are held;

FIG. 5 is a flowchart illustrating an embodiment of how an IoT device might connect to the gateway without the requirement of manually pairing;

FIG. 6 is a flowchart illustrating an embodiment of embedded software logic for a gateway scan of a Bluetooth™ device;

FIG. 7 is a flowchart illustrating an embodiment of embedded software logic for an IoT device; and

FIG. 8 is a common API provided by the Information Platform for Cloud applications.

### DETAILED DESCRIPTION OF PREFERRED EMBODIMENT(S) OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any specific embodiment illustrated.

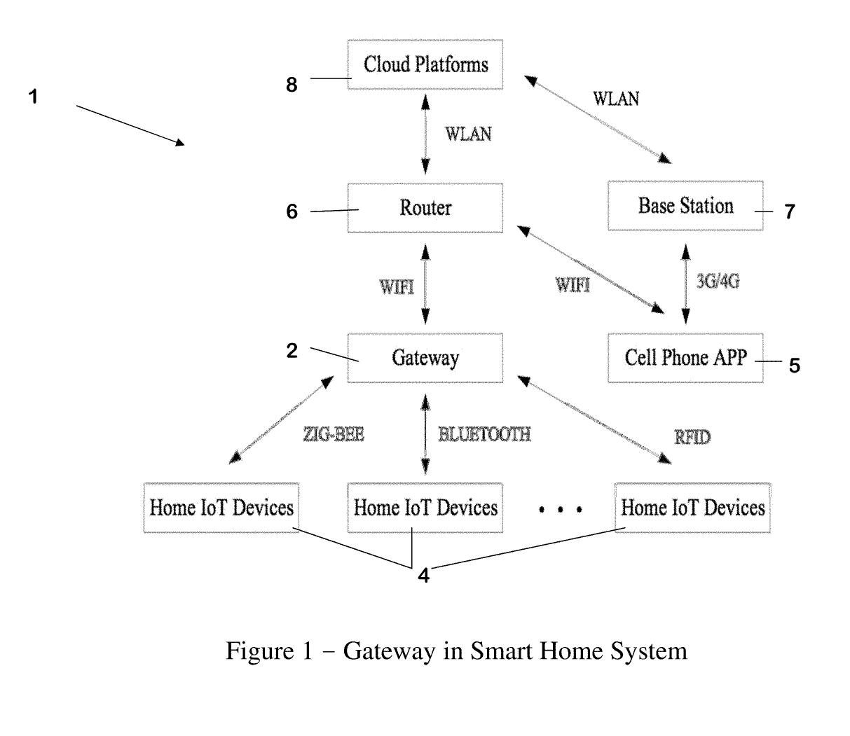

Referring to FIGS. 1-8, there is illustrated a system, generally designated by the numeral 10, and a method for automatically pairing IoT devices to Cloud-based applications. The particular illustrated system 10 is for a Bluetooth™ enabled device. However, while all the embodiments illustrated and described reference the use of Bluetooth™ enabled devices, it should be understood that the principles of the invention can be more broadly applied.

Current smart home systems, which are connected to by several Bluetooth or Zig-Bee devices, require a common interface for each device, and a manual pairing process. The devices are connected to the gateway so that data can be acquired, information can be transmitted, and then the devices can be controlled from a distance. The gateway becomes the center of the smart home system.

FIG. 1 illustrates a prior art system 1 showing the relationship of a gateway 2 to other components in the smart home system 1. In such a home, the gateway 2 plays a key role to connect various IoT devices 4, cellular phone apps 5 and/or home computer web applications 7, in order to both transfer data and allow for control of such devices (e.g., turning on/off). However, with this system 1 each IoT device 4 using Bluetooth protocol requires manual pairing before it can transfer data to a Cloud-based application 8 or be controlled. Pairing can take significant time and can present difficulties for some non-technical savvy people.

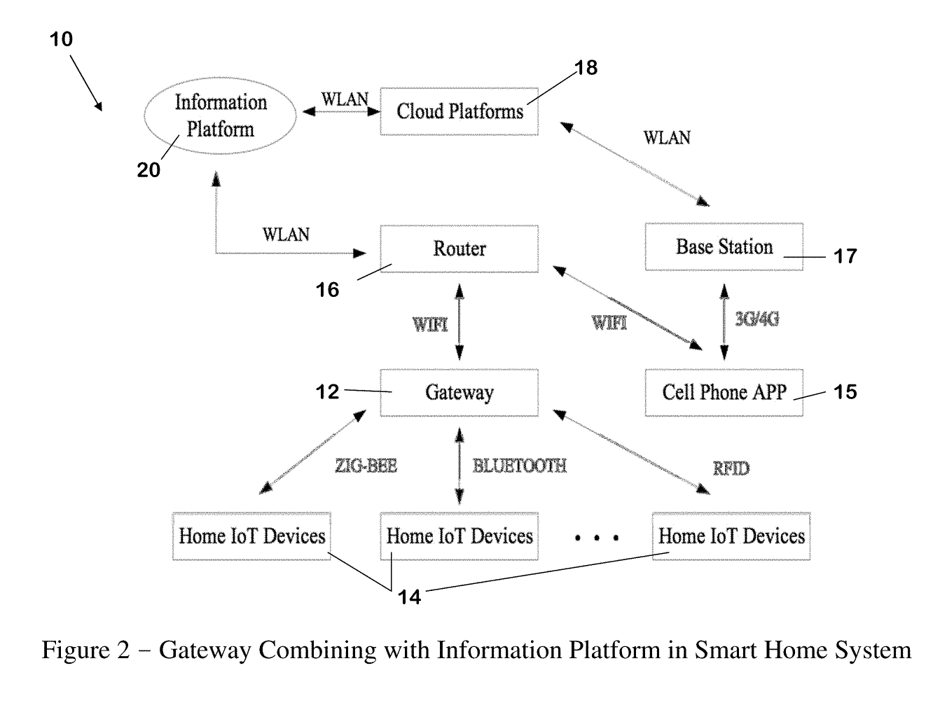

The disclosed system is a combined hardware and software solution to provide a gateway which allows connection to a Cloud-based Information Platform. The platform provides a list of potential devices around a home and offers Cloud-based applications a XML/Jason like common API. In short, the system provides a “smart” gateway by adding the Information Platform (see FIG. 2) to support the gateway's ability to connect Bluetooth devices without a pairing process and convert the data formats to a common interface.

In a preferred embodiment, the gateway uses WiFi to reach a home router and connect to the Internet. The gateway also connects to a Cloud-based Information Platform when powered on by using an embedded IP address in the gateway. With the Information Platform connected to the gateway, the gateway becomes programmable including the ability to (1) detect nearby Bluetooth capable IoT devices, (2) pair to any detected capable devices, and (3) offer common APIs to a Cloud application so that the Cloud application does not have to directly engage with the Bluetooth device manufacturer for the integration of the data or instruction format.

FIG. 2 illustrates an embodiment of the present system 10. This system 10 is similar to that of FIG. 1, but adds a Cloud-based Information Platform 20 to connect the gateway 12, via router 16, to a Cloud-based application 18. This system 10 offers common API to Cloud applications, and gives the gateway 12 the ability to connect IoT devices 14 without a long pairing process. However, for system 10 to work, the manufacturer of the IoT device 14 would be required to first register devices at the Information Platform 20 prior to releasing them to the market. This is the problem the present invention is designed to solve.

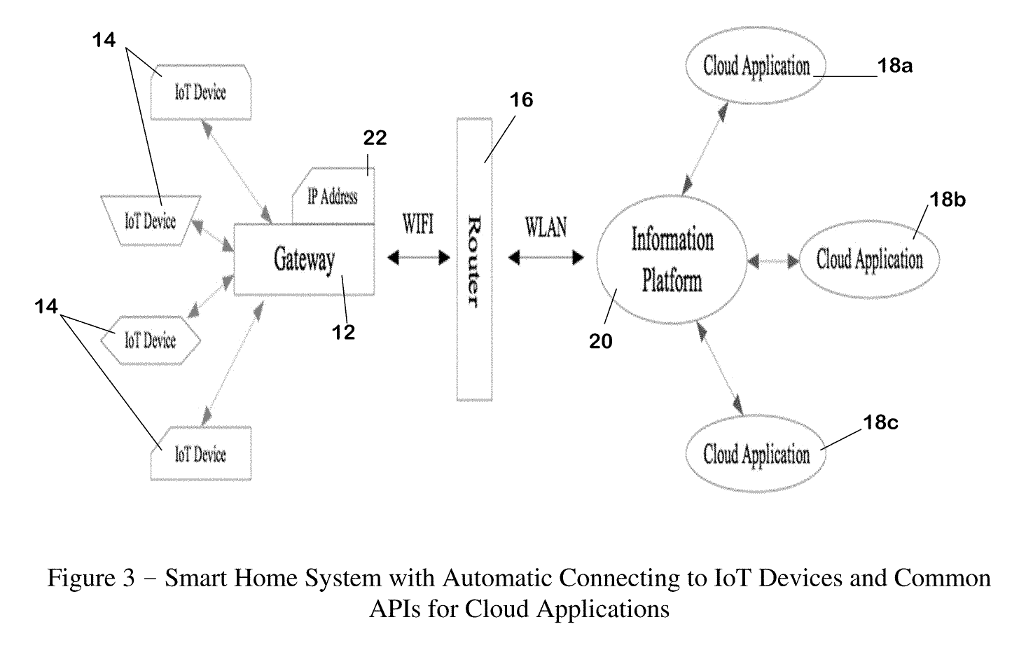

FIG. 3 illustrates the connection between the gateway 12 and the Information Platform 20 of FIG. 2. The gateway 12 has embedded the IP address 22 of the Information Platform 20. The connection to the Information Platform 20 is established when the gateway 12 is powered on, assuming the connection is made through the router 16. With the Information Platform 20, the gateway 12 is able to scan nearby IoT devices 14 (e.g., with Bluetooth protocol) and is able to automatically pair those IoT devices 14 which have been registered in the Information Platform 20. The Information Platform 20 converts the data and instruction sets from the IoT devices 14 to common APIs for Cloud applications 18a-c.

In detail, the Information Platform connected to the gateway provides a device lookup table in which previously registered Bluetooth devices (assigned by a solution provider which defines the scope of the gateway) are placed, including a device name, a MAC address, and a device UID.

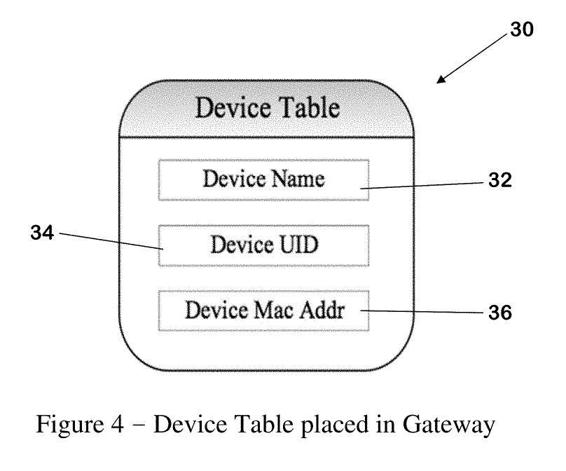

FIG. 4 is an illustration of an embodiment of a device lookup table 30 into which unique information on each registered IoT device 14 (FIGS. 2-3) is placed, including a unique device name 32, a unique device UID 34, and a unique device MAC address 36. The table 30 is initiated by the Information Platform 20 and it is uploaded into the gateway 12. To keep it current, the table 30 can be edited during runtime. The gateway 12 uses the table 30 for reference to determine whether any detected IoT devices 14 are matches for the devices in the table 30. If a match is found, the device is paired. In a typical case, the device's MAC address 36 is used to compare to see whether a match exists. However, any of the unique information may be used for validating a detected device.

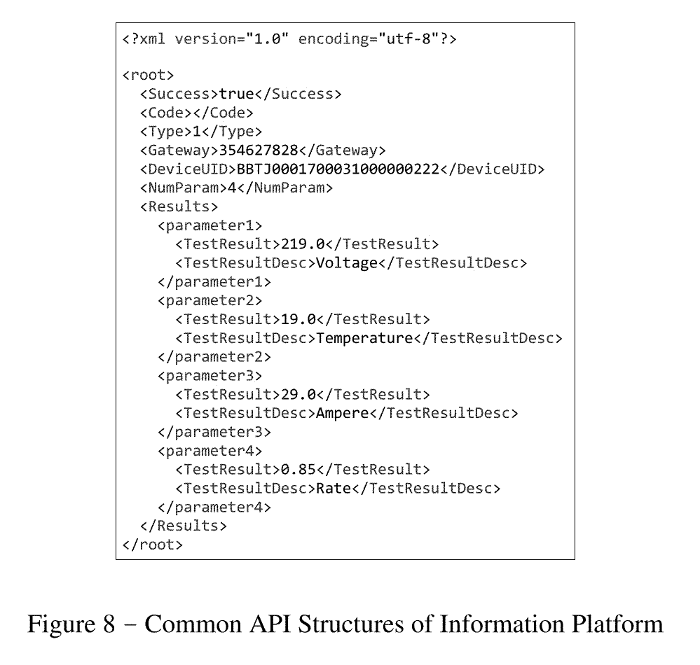

The device lookup table is built through a process whereby a manufacturer registers a Bluetooth device using the Information Platform 20. An important purpose of the process is to have the Information Platform 20 translate private data and instruction structure format to a XML/Jason format, as illustrated in FIG. 8, to create a common API so that any Cloud-based application 18 is able to access and understand the device. At the same time, the Information Platform 20 edits or updates the device lookup table 30 for the gateway 12. After connecting to the gateway 12, the Platform 20 transfers the device lookup table 30 to the gateway 12 for the automatic pairing process.

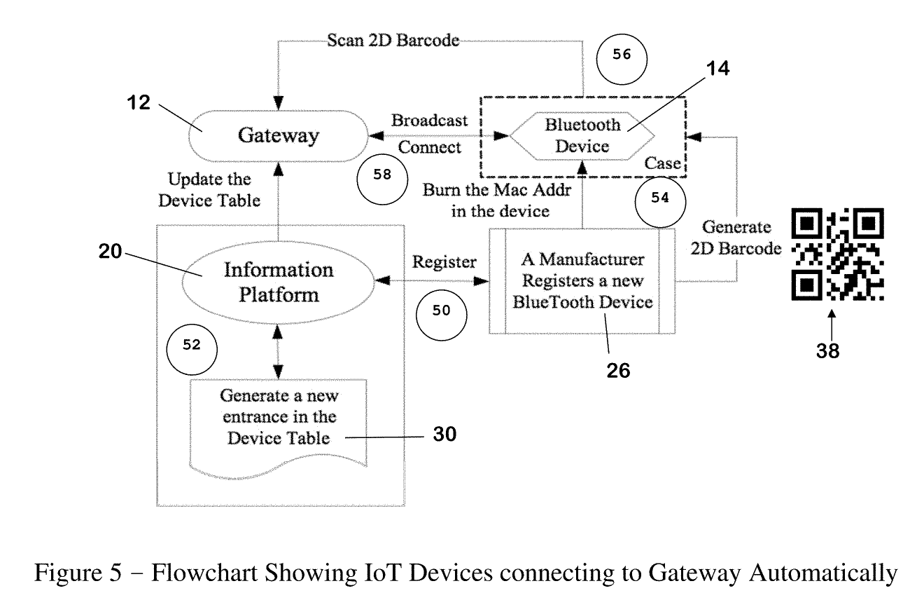

FIG. 5 illustrates a preferred embodiment of a procedure for connecting IoT devices 14 to the gateway 12 without a manual pairing process. At 50, the IoT device 14 is first registered in the Information Platform 20 by a manufacturer 26. At 52, the Information Platform 20 will edit the Device Lookup Table 30 and interpolate the data and instruction structure for common API. The Information Platform 20 generates a 2D bar code 38 in which the device name 32, UID 34, and MAC address 36 are placed and returns it to the manufacturer 26. At 54, the manufacturer 26 may place the 2D bar code 38 on packaging, a case or an operation manual of the IoT device 14 so it can be easily identified. At 56, the gateway 12 equips a camera (not shown) which is able to scan the 2D bar code 38 for the IoT device 14. The gateway 12 then extracts the device name 32, UID 34, and MAC address 36 from the bar code 38 and sends the information to the Information Platform 20 where it is compared to each entry in the Device Lookup Table 30. If a match occurs, the device name 32, UID 34 and MAC address 36 will be updated on a separate Lookup Table in the gateway 12, and pairs to it after the device 14 is powered on. Uploading only information for “local” devices scanned by the gateway 12 keeps the size of the table in the gateway 12 small and manageable.

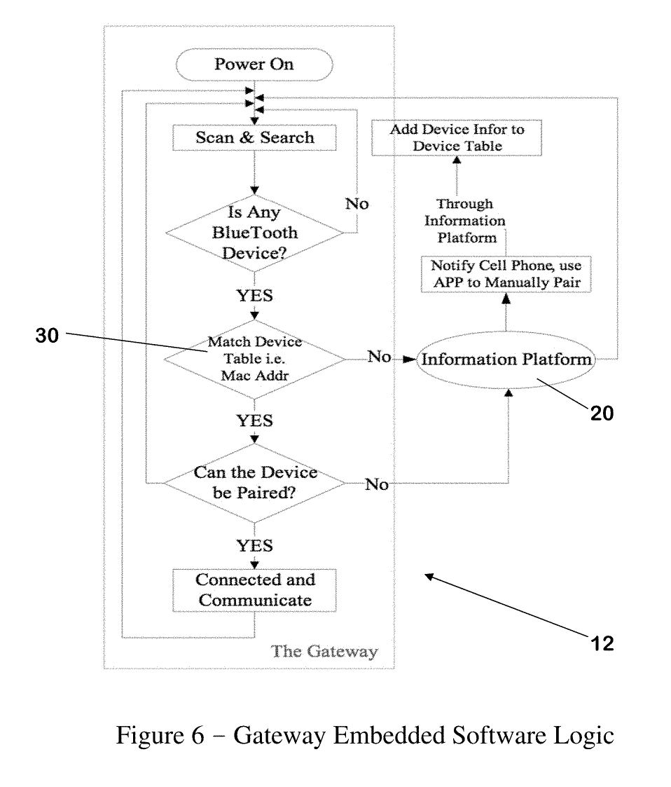

FIG. 6 is a flowchart of an embodiment of a system scan for registered Bluetooth devices. The scan is performed by embedded software logics of gateway 12. As illustrated, the gateway 12 scans for nearby Bluetooth devices when powered on. When an IoT device is detected, the gateway 12 first obtains its device name and MAC address (see FIG. 4). The gateway 12 then compares the device name and address with an updated device lookup table 30. If a match is found, the gateway uses the information to pair the device automatically (i.e., without any user input required). After being successfully connected, the gateway 12 waits for information from the device—e.g., the device may be a blood glucose meter, in which case the information might be results of repetitive blood tests. The gateway software may continually repeat the scan procedure to find other IoT devices nearby.

The registration process is fundamental to the present system and method. During registration, the manufacturer provides information on the command structure and data format of the device to allow the gateway to interpolate at runtime. It is only after completing registration of a device that a manufacturer will obtain a device unique identification (UID) assigned by the Information Platform (such UID can be provided by the manufacturer, so long as it is unique to a device). During the manufacturer packaging procedure, the device name, MAC address, and the device UID should be burned into the Bluetooth device. The unique code, which is preferably 2D barcode 38, is then generated into which the device name, MAC address, and the devices UID are placed. The 2D barcode 38 should be posted on a surface of the device packaging and/or on a device manual.

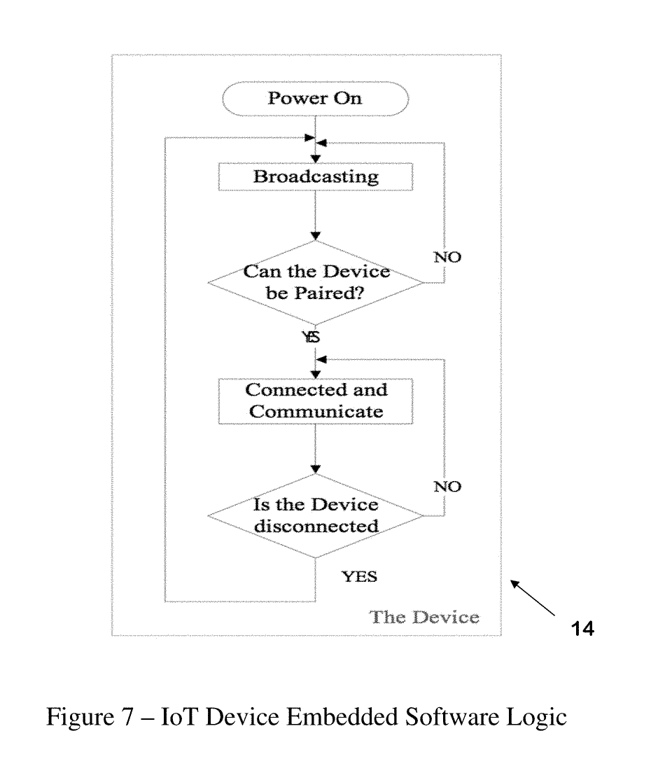

In use, when a new IoT device 14 is purchased or otherwise obtained by a user, the gateway 12 being equipped with a camera (not shown) is able to scan the 2D barcode 38 on device packaging, a device manual, or the like. The gateway 12 obtains the Bluetooth device information and waits for the device to be powered on. When the device is powered on, it will broadcast its name and MAC address, as the logic illustrates in FIG. 7. The gateway receives the information and automatically—i.e., without a manual process such as using cellular phone as intermediate to engage—begins a pairing process. Further, the gateway 12 is able to provide a common API to a Cloud application at runtime. It creates user friendly interface for both sides. It makes smart home much easy to penetrate to those who are uneasy with the use of technology and gadgets, and the solution providers who have a much wider selection than before.

If the device name and MAC address do not match any entries in the device lookup table 30, the gateway 12 sends the device name and MAC address to a cellular phone 15 (FIG. 2) which is bundled to the gateway 12 through the Information Platform 20. The IoT device 14 can be paired to the gateway 12 by a traditional procedure using the bundled cellular phone 15.

FIG. 7 is a flowchart illustrating an embodiment of broadcasting embedded software of an IoT device 14. The IoT device 14 broadcasts its unique name and MAC address to be picked up by any nearby gateway 12. As described above with reference to FIG. 6, the IoT device 14 will be paired to a gateway 12, if it matches an entry on an uploaded device table, or to a cellular phone 15 if it does not match an entry on the table. Once paired, the device 14 will transmit information to the gateway 12 for control and operation of the device.

FIG. 8 is an example of a common API which may be provided by the Information Platform 20 for Cloud applications 18 (see FIG. 3). The API can be in XML or Jason format. It is self-explanatory and has a flexible length to be decided based on the device runtime and type of the device. Each API carries a gateway ID (i.e., where it comes from), a device ID (i.e., which device around the gateway), and device information (e.g., data). The <Code> entrance is reserved. The <Type> is set to 1 if data is to be extracted, or set to 0 if data is not extracted (i.e., needs further interpolation).

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A system for automatically pairing an electronic device to a gateway to allow control and operation of the device through a cloud-based application, the system comprising:
an electronic device having an associated unique identification code;
a cloud-based information platform having an IP address, wherein the information platform generates and updates a first device table listing unique identification codes for registered electronic devices; and
a gateway comprising a sensor for detecting a broadcast from the electronic device, a code scanner for reading unique identification codes, memory having a second device table of registered electronic devices and the IP address of the information platform, and software for operating the sensor and scanner, wherein the gateway electronically connects to the cloud-based information platform using the stored IP address of the information platform;
wherein, when the gateway scans the unique identification code associated with the electronic device it sends the unique identification code to the information platform which compares the unique identification code associated with the electronic device against unique identification codes listed on the first device table and, if a match is found, returns additional information on the electronic device to the gateway which automatically pairs to the electronic device when it is powered on.

2. The system of claim 1, further comprising a router, wherein the gateway connects to the router using WiFi and the router connects to the information platform via the Internet.

3. The system of claim 1, wherein the information platform periodically updates the first device table with additional registered electronic devices.

4. The system of claim 1, wherein the electronic device can be controlled from cloud-based applications when paired with the gateway.

5. The system of claim 1, wherein the unique identification code is a 2D barcode.

6. The system of claim 1, wherein the electronic device comprises software which causes the device to continually broadcasts the unique identification code.

7. The system of claim 1, wherein a matching electronic device automatically pairs with the gateway at each power-on.

8. A method for automatically pairing electronic devices to cloud-based applications, the method comprising the steps of:
registering a plurality of electronic devices to a cloud-based information platform;
assigning each registered electronic device a unique identification;
creating a first device table on the information platform listing the unique identification of each of the plurality of registered electronic devices;
scanning from the gateway to detect a signal broadcast from a local electronic device capable of pairing with the gateway, wherein the signal broadcast comprises a first unique identification;
sending the first unique identification from the gateway to the information platform;
comparing the first unique identification against unique identifications of registered electronic devices listed on the device table stored on the information platform;
sending information about pairing with the local electronic device only if the first unique identification matches a unique identification of a registered electronic device; and
automatically pairing the gateway with the local electronic device having a first unique identification which matches a unique identification listed on the stored device table when the electronic device is powered on.

9. The method of claim 8, further comprising the step of periodically updating the device table at the information platform with additional registered devices.

10. The method of claim 8, further comprising the step of creating a second device table on the gateway comprising information about local electronic devices which match registered electronic devices on the information platform.

11. The method of claim 8, further comprising the step of translating information from the electronic device to create a common API.

12. The method of claim 11, further comprising the step of transmitting the common API to cloud-based applications.

13. The method of claim 8, further comprising the step of creating a common API for each registered device.

14. The method of claim 13, further comprising the step of storing the common API for each registered device at the information platform.

15. The method of claim 14, further comprising the steps of uploading the common API to a cloud-based application after pairing the electronic device to the gateway, and controlling the electronic device by the cloud-based application.

16. The method of claim 8, wherein the step of registering a plurality of electronic devices comprises the steps of acquiring device command structure and data format for each registered device, and creating a common API at the information platform.

17. The method of claim 8, wherein the unique identification is a 2D barcode.

18. The method of claim 8, wherein the unique identification comprises a device name and a MAC address.

19. The method of claim 15, further comprising the step of transmitting information from the paired electronic device to a cloud-based application through the gateway.

20. The method of claim 1, further comprising the step of pairing the local electronic device with the gateway through a cellular phone when no match is found for the first unique identification.
